(19) United States
(12) Patent Application Publication
(10) Pub. No.: US 2008/0231869 A1
(43) Pub. Date: Sep. 25, 2008

(54) Method and apparatus for displaying document image, and computer program product

(76) Inventor: Katsushi Morimoto, Tokyo (JP)

Correspondence Address: HARNESS, DICKEY & PIERCE, P.L.C., P.O. BOX 8910, RESTON, VA, 20195, US

(21) Appl. No.: 12/076,395

(22) Filed: Mar. 18, 2008

(30) Foreign Application Priority Data
Mar. 19, 2007 (JP) 2007-070717

(51) Int. Cl. G06K 15/00

(52) U.S. Cl. 358/1.1; 358/1.2

(57) ABSTRACT

Full-size image data is displayed on a first area on a display unit and detailed image data are displayed in a second area on the display unit. A mark indicating a position of the detailed image data in the full-size image data is displayed in the full-size image data. The detailed image data displayed in the second area is automatically changed to new detailed image data based on a predetermined direction with respect to the document image data, and the mark is shifted to a position of the new detailed image data in the full-size image data.

### CROSS-REFERENCE TO RELATED APPLICATIONS

The present application claims priority to and incorporates by reference the entire contents of Japanese priority document 2007-070717 filed in Japan on Mar. 19, 2007.

### BACKGROUND OF THE INVENTION

1. Field of the Invention

The present invention relates to a technology for displaying document image data.

2. Description of the Related Art

Along with improvements in the technology related to computer peripheral equipment, it has become possible to acquire higher resolution document images of a document in image forming apparatuses. Hereinafter, the document image is defined as image data containing a text.

Japanese Patent Application Laid-open No. H09-305345 discloses a conventional technology in which a paper document, such as a book, is scanned to obtain image data thereof, and the image data is displayed on a monitor for a user to see. When the user performs operation to select the previous page or the following page of the current page, the displayed image data is changed to image data of the previous page or the following page in accordance with the user's operation.

In the conventional technology, it is assumed that characters in text displayed on the monitor are large enough to be recognized by a user, even if an entire page is displayed on the monitor. However, when document image obtained by scanning a document is displayed on a monitor of a personal computer (PC), adjustment is performed on a size of the document image to display the whole of the document image on a display screen of the monitor. Because of such adjustment, characters in the image data become too small for a user to recognize contents of the document.

On the other hand, when a character in the image data is displayed in an appropriate size such that the user can easily recognize the contents of the document, the whole of the document image cannot be displayed on the screen. For this reason, it is difficult for the user to obtain the overall layout of the document image. Therefore, when the user desires to change a display area of the document image in accordance with a reading order of the document, it is difficult for the user to appropriately change the display area from one column to another.

For example, a function of a magnifying glass is available in MS Windows (registered trademark) as a function of enlarging a predetermined display area. A surrounding area of a point over which a mouse pointer is placed is displayed as an enlarged document image by using the magnifying glass. With this configuration, it is possible to display an enlarged image of a part of the whole document image displayed on a display screen.

However, the document image enlarged by the magnifying glass has the following problem. Assume that the whole of a large-size document image is displayed on a display screen by reducing an image size of the document image, and a desired area in the reduced document image is enlarged by using the magnifying glass. Because the enlarged document image is grainy, it is difficult for a user to read contents of a document. Specifically, because the image size of the original document image is reduced in order to display the whole of the document image on the display screen, the displayed document image does not contain image data as much as the original document image.

Moreover, when a user views the document image by using the magnifying glass, it is necessary for the user to manually move a pointing device in accordance with a reading order of the document, which causes complicated operation to a user. Specifically, it is difficult for a user to manually control linear movement of the pointing device in a horizontal direction or a vertical direction, and therefore the user often moves the pointing device in an oblique direction or in a wavy manner, although the user desires to move the pointing device in the horizontal direction or the vertical direction.

Furthermore, in Japanese Patent Application Laid-open No. H09-305345, if the whole of the document image in one page is displayed on the monitor, it is easy to perform operation on the document image. However, because the user cannot recognize the displayed characters in the document image when the whole of the document image is displayed on the monitor, it can be assumed that the user needs to perform complicated operation. This causes an increase in operation load of the user.

### SUMMARY OF THE INVENTION

It is an object of the present invention to at least partially solve the problems in the conventional technology.

According to an aspect of the present invention, there is provided an apparatus for displaying a document image including a full-size image-data generating unit that generates full-size image data from document image data containing a document with an image size larger than a size of a screen of a display unit by reducing the image size of the document image data to an image size small enough for a user to view a whole content of the document image data when displayed on the screen; a document-image-data display unit that displays a part of the document image data on a first display area in the screen as target image data, the first display area having a size smaller than the size of the screen; a full-size image display processing unit that displays the full-size image data on a second display area in the screen, and displays a display range mark in the full-size image data displayed on the second display area, wherein the display range mark indicates position of the target image data in the full-size image data; and a display-area changing unit that changes the target image data displayed on the first display area to a new target image data based on a predetermined direction with respect to the document image data, and shifts the display range mark displayed on the second display area to a position of the new target image data in the full-size image data.

According to another aspect of the present invention, there is provided a method for displaying a document image including generating full-size image data from document image data containing a document with an image size larger than a size of a screen of a display unit by reducing the image size of the document image data to an image size small enough for a user to view a whole content of the document image data when displayed on the screen; displaying a part of the document image data on a first display area in the screen as target image data, the first display area having a size smaller than the size of the screen; displaying the full-size image data on a second display area in the screen; displaying a display range mark in the full-size image data displayed in the second display area, wherein the display range mark indicates position of the target image data in the document image data; changing the target image data displayed on the first display area to a new target image data based on a predetermined direction with respect to the document image data; and shifting the display range mark displayed on the second display area to a position of the new target image data in the full-size image data.

According to another aspect of the present invention, there is provided a computer program product comprising a computer usable medium having computer readable program codes embodied in the medium that, when executed, causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a display processing device according to a first embodiment of the present invention;

FIG. 2 is an example of document image data acquired by the display processing device;

FIG. 3 is a schematic diagram for explaining areas of document elements specified by a document-element extracting unit shown in FIG. 1;

FIG. 4 is a schematic diagram for explaining areas of lines specified by a document-element extracting unit according to a modification of the first embodiment;

FIG. 5 is an example of display control data generated by a display-control-data generating unit shown in FIG. 1;

FIG. 6 is a schematic diagram of a structure of a tag included in the display control data;

FIG. 7 is an example of the display control data when one document has a plurality of pages;

FIG. 8 is an example of a screen display of a display unit in which document image data is displayed by a display control unit shown in FIG. 1;

FIG. 9 is a schematic diagram for explaining an example of movement of a display area of detailed image data by a display-area change control unit shown in FIG. 1;

FIG. 10 is a schematic diagram for explaining changing of a display area of detailed image data by the display-area change control unit;

FIGS. 11A to 11C are schematic diagrams for explaining operation performed by a setting unit shown in FIG. 1 for determining an area to be displayed as detailed image data;

FIG. 12 is a flowchart of operation performed by the display processing device shown in FIG. 1 for displaying acquired document image data;

FIG. 13 is a block diagram of a display processing device according to a second embodiment of the present invention;

FIG. 14 is an example of a display screen of the display unit in which document image data is displayed by a display control unit shown in FIG. 13;

FIG. 15 is a flowchart of operation performed by the display processing device shown in FIG. 13 for displaying acquired document image data;

FIG. 16 is an example in which the display processing device displays only detailed image data on a display screen by using a projector according to the second embodiment; and

FIG. 17 is a block diagram of a hardware configuration of a PC that executes a computer program for performing functions of the display processing device shown in FIG. 1 or 13.

### DETAILED DESCRIPTION OF THE PREFERRED EMBODIMENTS

Exemplary embodiments of the present invention are explained in detail below with reference to the accompanying drawings.

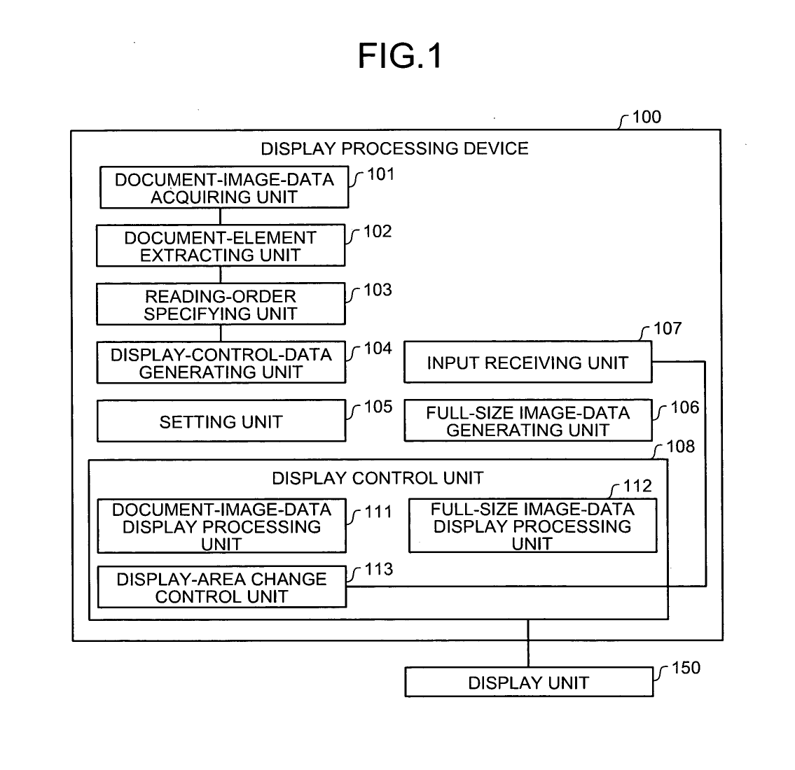

FIG. 1 is a block diagram of a display processing device 100 according to a first embodiment of the present invention. The display processing device 100 includes a document-image-data acquiring unit 101, a document-element extracting unit 102, a reading-order specifying unit 103, a display-control-data generating unit 104, a setting unit 105, a full-size image-data generating unit 106, an input receiving unit 107, and a display control unit 108. The display processing device 100 performs operation to display acquired document image data.

Although it is assumed that the display processing device 100 is implemented by using a PC, other electronic devices such as a personal digital assistance (PDA) can be used for the display processing device 100.

A display unit 150 is connected to the display processing device 100. The display unit 150 can have any configuration as long as it includes a display screen (not shown). In the first embodiment, it is assumed that the display unit 150 is a monitor.

The input receiving unit 107 receives a command from a user. A display-area change control unit 113 controls display on the display screen in accordance with the received command. The display-area change control unit 113 will be described later in detail. An input device (not shown) by which a user inputs a command to the input receiving unit 107 can be any type of input device.

For example, the input device can be a direction key of a keyboard, a lever, a joystick, a jog, or other type of pointing devices. An area to be displayed out of document image data (hereinafter, “display area”) can be changed in accordance with an operation command that is received from a user through the input receiving unit 107. By using the input device, a user inputs a command to move the display area of the document image data in one dimension, i.e., either a forward direction or a backward direction with respect to a reading direction of a document. Therefore, it is easier for a user to move the display area compared with the case in which a user inputs a command to move the display area in two dimensions, i.e., a forward/backward direction and an upward/downward direction by using the magnifying glass. The operation in accordance with a command to move the display area will be described later in detail.

If the display area of document image data is sequentially moved depending on contents of a document (for example, a reading order of a document), the input receiving unit 107 receives a command to move the display area of the document image data in one dimension (the forward direction or the backward direction). Thus, the display processing device 100 makes it easier to perform operation as compared to the same in the conventional technology.

The document-image-data acquiring unit 101 acquires document image data to be displayed. The document image data can be acquired by using any method, for example, by scanning a paper text containing a document by a scanner to obtain document image data thereof, or acquiring document image data that is stored in a hard disk drive (HDD) (not shown) in advance.

The document image data is image data containing a document. For example, the image data includes the one that is obtained by scanning a paper text containing a document by a scanner or the like, or the one that is converted from text data.

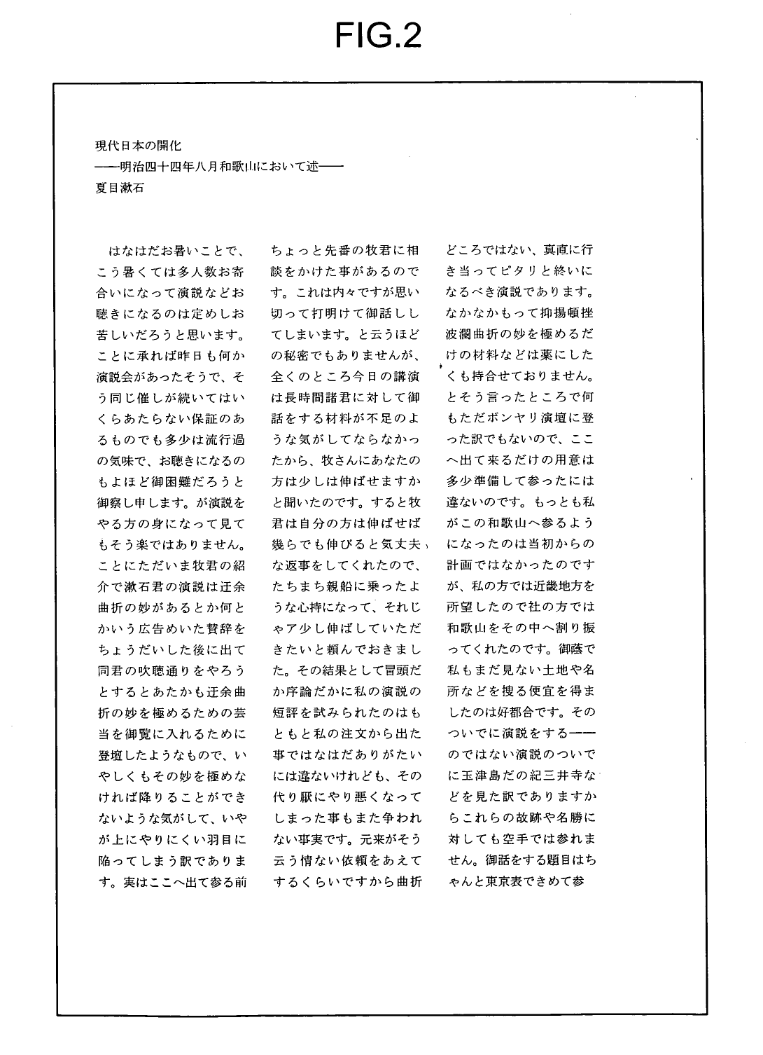

FIG. 2 is an example of document image data acquired by the display processing device 100. In the first embodiment, it is assumed that the document image data contains three columns in which the line direction is horizontal.

Referring back to FIG. 1, the document-element extracting unit 102 extracts each document element contained in the document image data. An area can be specified for each document element using the extracted document element. In the first embodiment, the document element is determined as a column. The document-element extracting unit 102 specifies an area of a column contained in the document image data. Furthermore, the document-element extracting unit 102 may extract a graphic or a photographic image contained in the document, as a document element.

As a method of specifying an area of the column by the document-element extracting unit 102, any method such as a method described in Japanese Patent Application Laid-open No. H05-233873 may be used. In the method described in the Patent Application, a standard character size is determined, and blocks obtained by dividing the image data using the standard character size are classified into a graphic block and a text block, and text blocks are integrated to extract a line block. And extracted line blocks are further integrated to extract an area for each column. The document-element extracting unit 102 according to the first embodiment specifies an area range for each column and graphic (including photographic images) by using the method, and specifies a line direction for each column from the extracted line blocks.

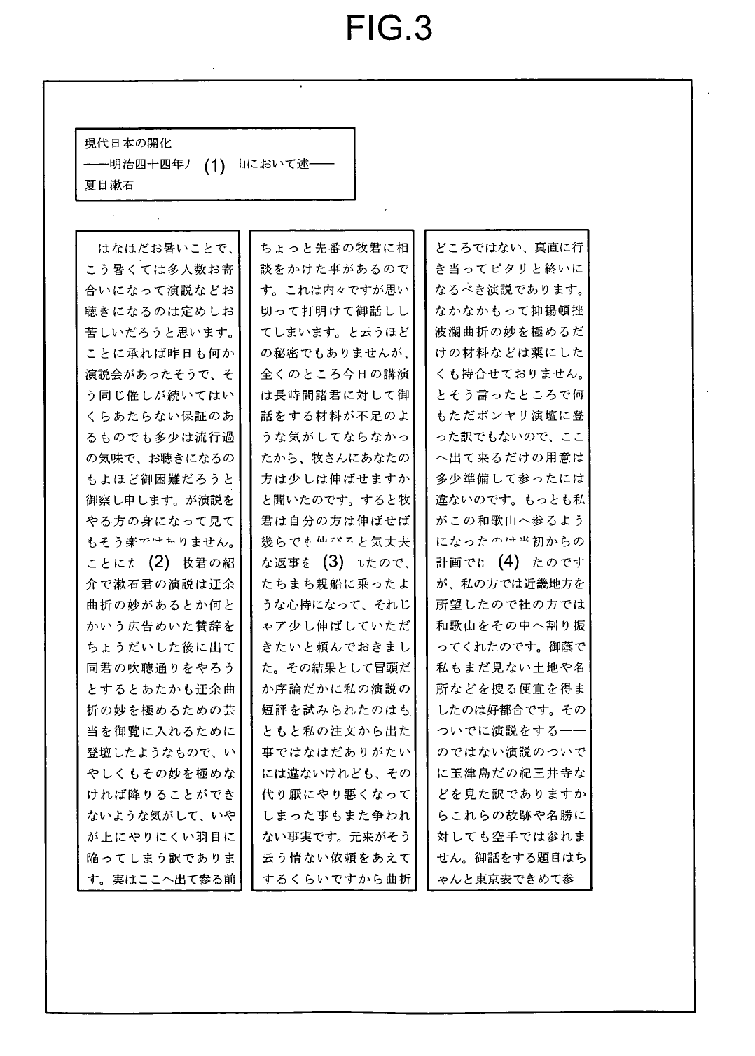

FIG. 3 is a schematic representing areas of document elements specified by the document-element extracting unit 102. In the areas for each document element shown in FIG. 3, columns are extracted as the document element. These columns are set as ranges to be displayed.

However, the document element to be extracted is not limited to the column, and hence a character or a line may be the document element. As a modification of the first embodiment, a case where a line is extracted as the document element is explained below.

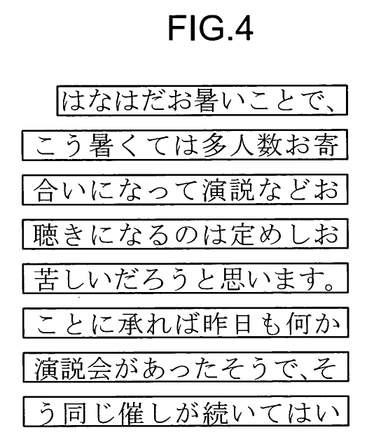

FIG. 4 is a schematic representing areas of lines specified by the document-element extracting unit 102, as a modification of the first embodiment. In this modification, an area for each line as shown in FIG. 4 is set as an object to be displayed, and the order of reading lines is set by the reading-order specifying unit 103. The display processing device 100 explained later controls the lines so as to be displayed in their set order. Any one of these technologies may be used irrespective of known technologies.

Referring back to the first embodiment, the reading-order specifying unit 103 specifies the order of reading the extracted columns. As a method of specifying the order of reading them, any method may be used, and, for example, a method described in Japanese Patent Application Laid-open No. H07-192084 may also be used. By using the method described in Japanese Patent Application Laid-open No. H07-192084, it is possible to specify whether the area of each document element indicates a title or simply indicates a column. Therefore, the reading-order specifying unit 103 according to the first embodiment specifies the reading order of document elements and specifies whether the area of each document element indicates a title or a column, by using the method.

The display-control-data generating unit 104 generates display control data according to the result of extraction by the document-element extracting unit 102 and the result of specification by the reading-order specifying unit 103. In the first embodiment, the display-control-data generating unit 104 generates display control data that includes an area and a line direction for each column extracted by the document-element extracting unit 102, a reading order of a column specified by the reading-order specifying unit 103, and also includes information as to whether each area is a column or a title.

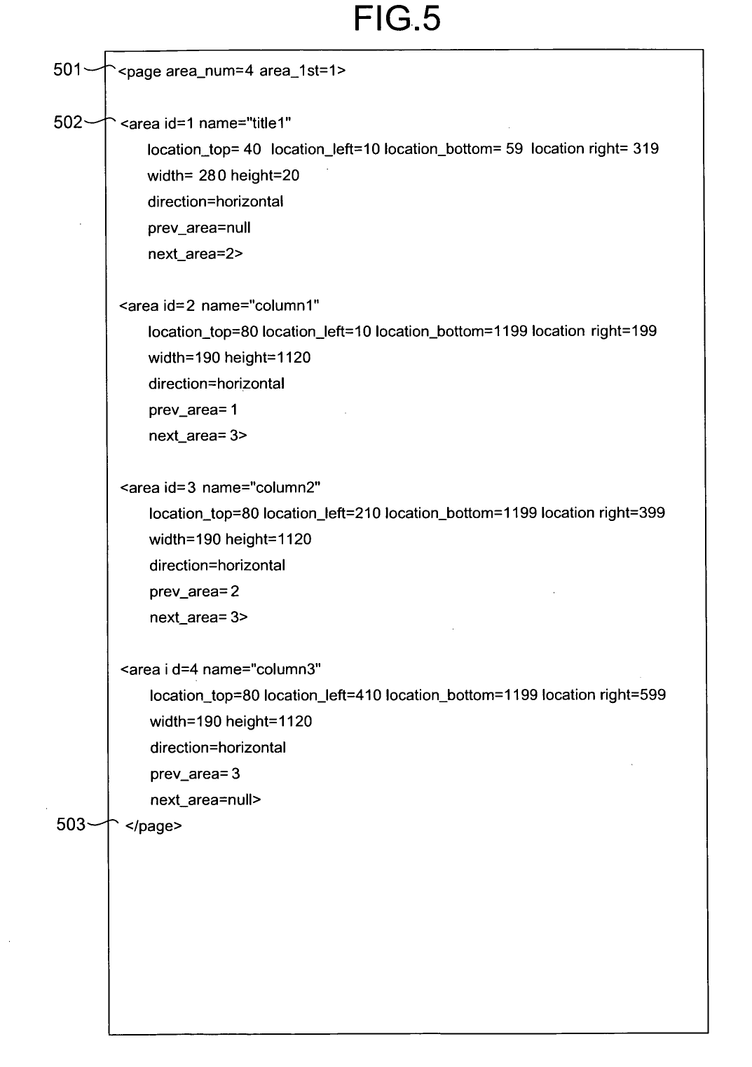

FIG. 5 is an example of the display control data generated by the display-control-data generating unit 104. In the display control data, the information is defined in a text format using tags. Note that the display control data is the display control data for the document image data shown in FIG. 2. Before explaining the details of the display control data shown in FIG. 5, the tag of the display control data is explained first.

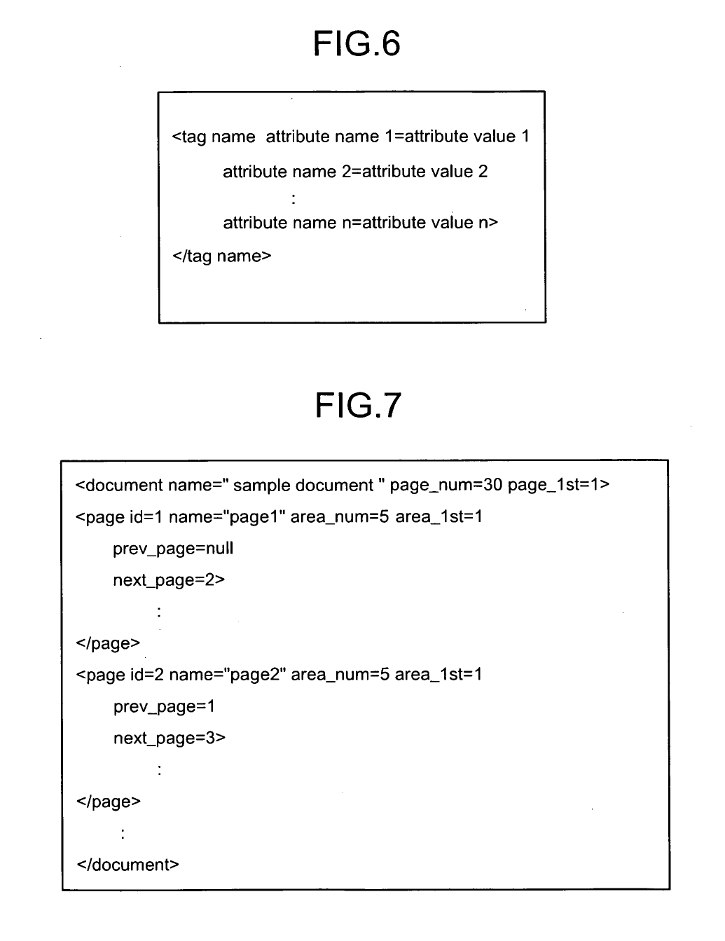

FIG. 6 is a schematic of a structure of the tag included in the display control data. A tag name and an attribute corresponding to a tag can be set in the tag. A tag name which can be set includes ‘document’, ‘page’, ‘area’, and so on. If the tag name is ‘document’, the relevant tag corresponds to one document. If the tag name is ‘page’, the relevant tag corresponds to one page, and if the tag name is ‘area’, the relevant tag corresponds to one area.

When an attribute of a tag is to be set, an attribute name and a parameter of the attribute are described. Moreover, any attribute may be set in a tag. An example of an attribute name used in the embodiments includes ‘area_num’, ‘area_{—}1st’, ‘name’, ‘location_xxx’, ‘width’, ‘height’, ‘direction’, ‘prev_xxx’, and ‘next_xxx’.

The ‘area_num’ represents the number of areas contained in a document element corresponding to a relevant tag. The ‘area_{—}1st’ represents ID indicating a first area to be read of areas contained in the document element. The ‘name’ represents a name of the document element. The ‘location_xxx’ represents coordinates indicating end points of an area of the document element. The ‘width’ represents a width of the area of the document element, and the ‘height’ represents a height of the area of the document element. The ‘direction’ represents a line direction in the document element. The ‘prev_xxx’ represents ID indicating a previous document element in the reading order. The ‘next_xxx’ represents ID indicating a next document element in the reading order. Display control data is generated by using these tags and attributes.

Referring back to FIG. 5, a <page> tag 501 indicates an outline of a page. At first, ‘area_num=5’ indicates five areas within the page, and ‘area_{—}1st=1’ indicates that id as a first area to be read is 1. Then, a </page> tag 503 indicates an end of information for the page.

A <area> tag 502 indicates detailed information for a corresponding area. At first, ‘id=1’ indicates that ID is 1, ‘name=“title”’ indicates that an area name is “title”. Further, ‘location_top=10 location_left=10 location_bottom=29 location_right=599’ indicates a range of an area by upper left coordinates (10, 10)—lower right coordinates (599, 29). Also in the tag 502, ‘width=590’ indicates that the width is 590, and ‘height=20’ indicates that the height is 20. If either information for the under right coordinates or information for the width and the height is set, the range of the area can be identified, and hence, the other one of the two pieces of information may be omitted.

Furthermore, ‘direction=horizontal’ indicates that the line direction is horizontal. The attribute ‘prev_area=null’ indicates that there is no previous area of the area in the reading order, and ‘next_area=2’ indicates that ID of the area as the next one in the reading order is 2. For example, when ‘next_area=2’ is changed to ‘next_area=3’, the next area of the area having id=1 in the reading order is changed to the area of id=3. In other words, the link in the reading order is defined by the ‘prev_area’ and ‘next_area’, and by changing the link, the reading order can be changed.

It is also possible to define that the area is text in the <area>tag, although the explanation is omitted in FIG. 5. In this case, ‘type=“text”’ as an attribute is simply specified in the tag. To identify a type of the area, by specifying an attribute such as ‘figure’ and ‘photo’ in addition to ‘text’, the area can be defined as a graph or a photograph. This allows the display processing device 100 to specify the type for each area. The type is information extracted by the document-element extracting unit 102.

When the area is a graph or a photograph, the document may often include description therefor. In this case, the display control data can store therein an association between the area of the graph or of the photograph and the location of its description in the document. For example, it may be considered that a coordinate area of the location of the description in the document is kept in the tag indicating the graph or the photograph. This enables to identify the graph or the photograph and the location of the description associated with it in the display processing device 100 that loads the display control data.

The information described in the display control data as shown in FIG. 5 is not limited to only one page. FIG. 7 is an example of display control data when one document has a plurality of pages. It can be recognized that a plurality of <page> tags are described in a <document> tag as shown in FIG. 7. It is also recognized by attributes defined in the <document> tag that a document name is “sample document”, the number of pages are 30 pages, and the ID of an initial page in the reading order is 1. The attributes defined in the <page> tag and the tag are the same as these explained with reference to FIG. 5, and explanation thereof is therefore omitted.

As described above, because the display-control-data generating unit 104 generates the display control data, the display processing device 100 need not analyze the document image data every time the display processing device 100 performs operation to display the document image data. Thus, it is possible to reduce processing load on the display processing device 100. Moreover, the document image data and the display control data can be fed to some other device, so that that device can perform operation to display the document image data in the same manner as the display processing device 100.

The display processing device 100 can specify a range of an area to be displayed by using coordinates of an area of a document element and a size of the area. The coordinates and the size of the area are contained in the display control data. Furthermore, the display processing device 100 can determine a direction to move the display area on the display screen based on a line direction of each document element contained in the document image data, and an area of the document element.

The display-control-data generating unit 104 may embed a standard character size determined in the document-element extracting unit 102, in the display control data. When it is embedded therein, the display processing device 100, explained later, can easily determine whether the user can read a character displayed on the screen based on the standard character size.

The full-size image-data generating unit 106 generates, from the document image data acquired by the document-image-data acquiring unit 101, full-size image data that is used for displaying the whole of the document image data in the display unit 150. The full-size image data is generated by changing an image size of the document image data in such a manner that the image size of the document image data is equal to or smaller than a screen size of the display unit 150. Because the number of pixels of the document image data is usually larger than the number of pixels of the display screen of the display unit 150, the image size of the document image data is reduced to generate the full-size image data.

The display control unit 108 includes a document-image-data display processing unit 111, a full-size image-data display processing unit 112, and the display-area change control unit 113. The display control unit 108 controls display of document image data in the display unit 150.

The document-image-data display processing unit 111 displays detailed image data that contains a detail of acquired document image data in the display unit 150. The detailed image data is generated by extracting a part of the document image data, and the detailed image data is displayed in a predetermined display area on the display screen of the display unit 150. As described above, the document-image-data display processing unit 111 causes the display unit 150 to display the detailed image data that is extracted from the document image data rather than enlarged from the full-size image data. In this manner, the document-image-data display processing unit 111 can prevent a situation where characters in the detailed image data are too grainy to read.

The full-size image-data display processing unit 112 causes the display unit 150 to display the full-size image data generated by the full-size image-data generating unit 106. The full-size image-data display processing unit 112 also causes the display unit 150 to display, in an area of the displayed full-size image data, a detailed-image area indicator 804 that indicates a range of the part of the document image data that is displayed as the detailed image data by the document-image-data display processing unit 111.

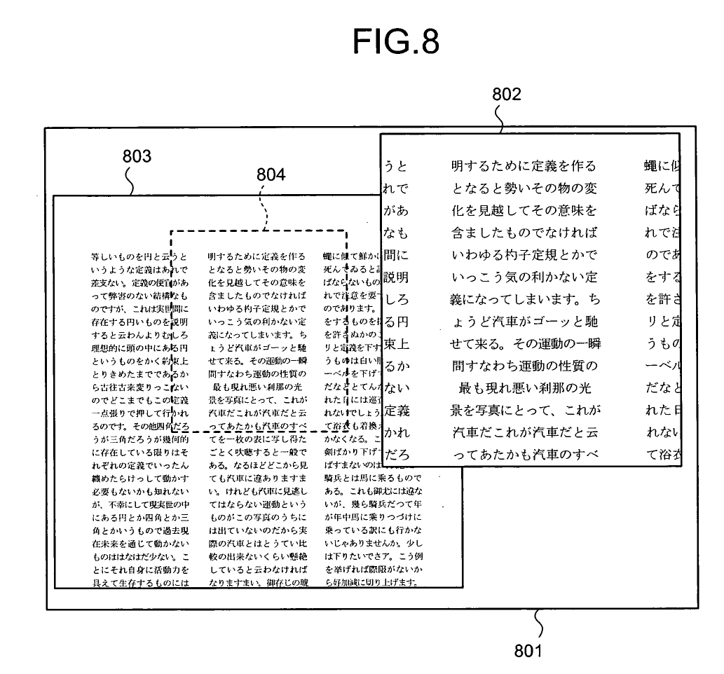

FIG. 8 is an example of a screen display of the display unit 150. A display screen 801 displays two windows 802 and 803. Detailed image data is displayed on the window 802 by the document-image-data display processing unit 111. Although the document-image-data display processing unit 111 displays a part of the document image data as the detailed image data in the display unit 150, the setting unit 105 performs setting of an area to be displayed as the detailed image data. The setting unit will be described later in detail.

Full-size image data is displayed on the window 803 by the full-size image-data display processing unit 112. Furthermore, the detailed-image area indicator 804 is displayed by the full-size image-data display processing unit 112 in an area of the full-size image data displayed on the window 803. The detailed-image area indicator 804 indicates a range of the detailed image data displayed on the window 802. Thus, a user can easily understand contents of the document by viewing the detailed image data, and see a position of the area displayed as the displayed detailed image data in the document image data.

The display-area change control unit 113 changes the area displayed as the detailed image data on the window 802 in response to an operation command that is received from a user through the input receiving unit 107. Specifically, when a user has finished reading displayed contents in the detailed image data, and inputs an operation command to move the display area of the detailed image data to the input receiving unit 107, the display-area change control unit 113 changes the display area of the detailed image data to a new area in accordance with a reading order of columns contained in the document image data. The display-area change control unit 113 changes the area displayed as detailed image data in one dimension (the forward direction or the backward direction with respect to the reading direction) in response to an operation command from a user. Specifically, the display-area change control unit 113 specifies a direction to move the display area of the detailed image data.

When an area (such as a column or a title) in acquired document image data is to be displayed as the detailed image data in the display unit 150, the display-area change control unit 113 determines whether the width of the area in the line direction is wider than that of the display area of the detailed image data based on the display control data contained in the document image data. Based on a result of such determination, the display-area change control unit 113 determines a direction to move the display area of the detailed image data.

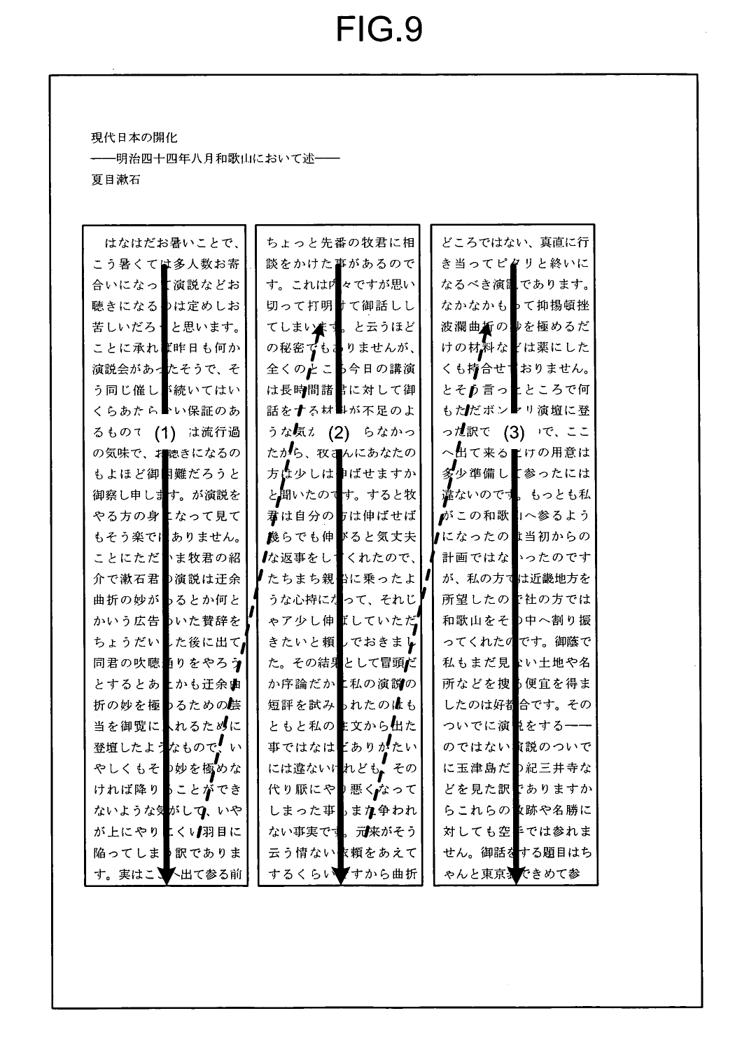

FIG. 9 is a schematic diagram for explaining an example of movement of the display area of the detailed image data by the display-area change control unit 113. The display-area change control unit 113 determines an order of displaying columns contained in document image data based on the display control data. In the example shown in FIG. 8, the display-area change control unit 113 determines the order of reading column (1), column (2), and column (3).

The display control data contains a setting about a line direction of each column as an attribute. As shown in FIG. 5, if the display control data contains the setting of ‘direction=horizontal’ in the <area> tag 502, the display-area change control unit 113 determine that the line direction of the column is horizontal. When the display-area change control unit 113 determines that the width of the column in the horizontal direction is equal to or narrower than the width of the display area of the detailed image data, the display-area change control unit 113 determines that the display area of the detailed image data is to be moved in a downward direction, i.e., the direction indicated by solid arrow lines shown in FIG. 9. As a result, the display-area change control unit 113 moves the display area in the downward direction. After the end of the column is displayed, the display-area change control unit 113 displays a beginning of a next column.

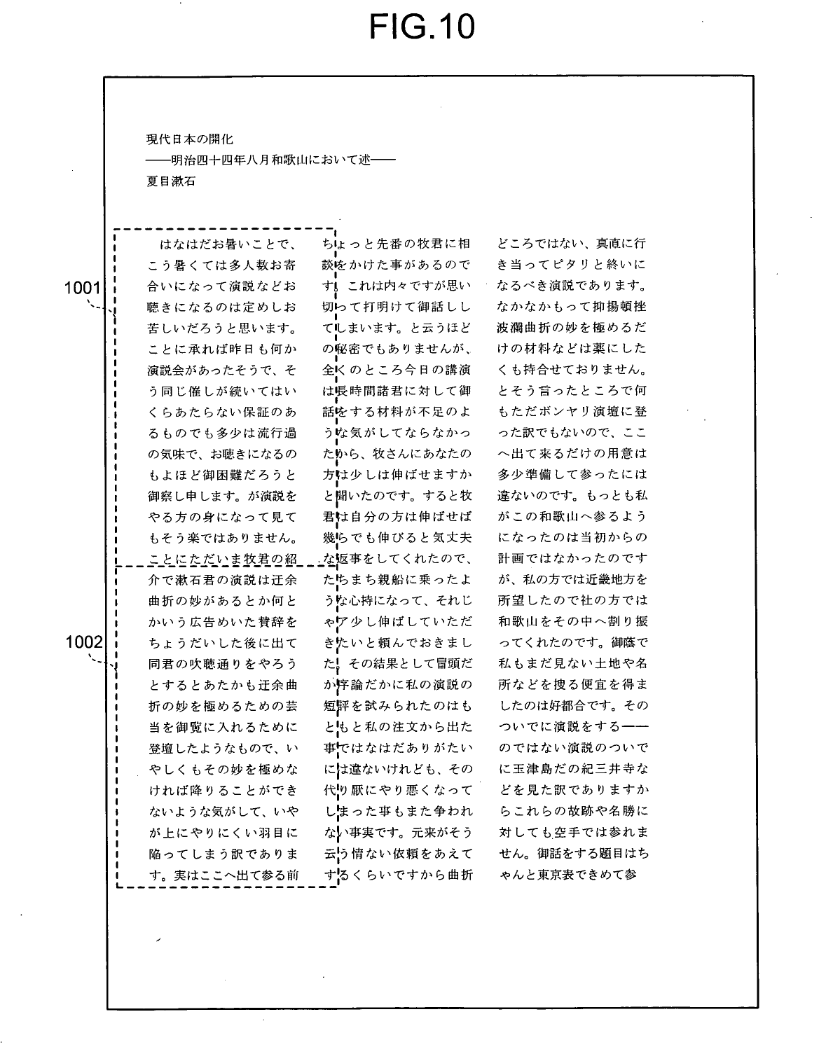

FIG. 10 is a schematic diagram for explaining changing of the display area of the detailed image data by the display-area change control unit 113. An area 1001 is a beginning area of the column (1), and it is displayed first as the detailed image data by the document-image-data display processing unit 111. When the input receiving unit 107 receives from a user a command to move the display area of the detailed image data in the forward direction, the display-area change control unit 113 changes the display area from the area 1001 to an area 1002 in response to the received command. If the input receiving unit 107 receives a command to move the display area in the forward direction after the display area has moved to the area 1002, the display-area change control unit 113 changes the display area to the column (2). In this manner, the user can view the contents of all the columns without missing any part of the contents.

When the display-area change control unit 113 determines that the width of a column in the line direction is wider than the width of the display area of the detailed image data, and the input receiving unit 107 receives a command to move the display area of the detailed image data in the forward direction, the display-area change control unit 113 moves the display area in the line direction of the column, so that the right end of the column is displayed. Afterwards, the display-area change control unit 113 moves down the display area by one line, and displays the left end of the column. In this manner, a user can view all of the contents of the columns without missing any part thereof simply by entering a command to move the display area in the forward direction by using the input device.

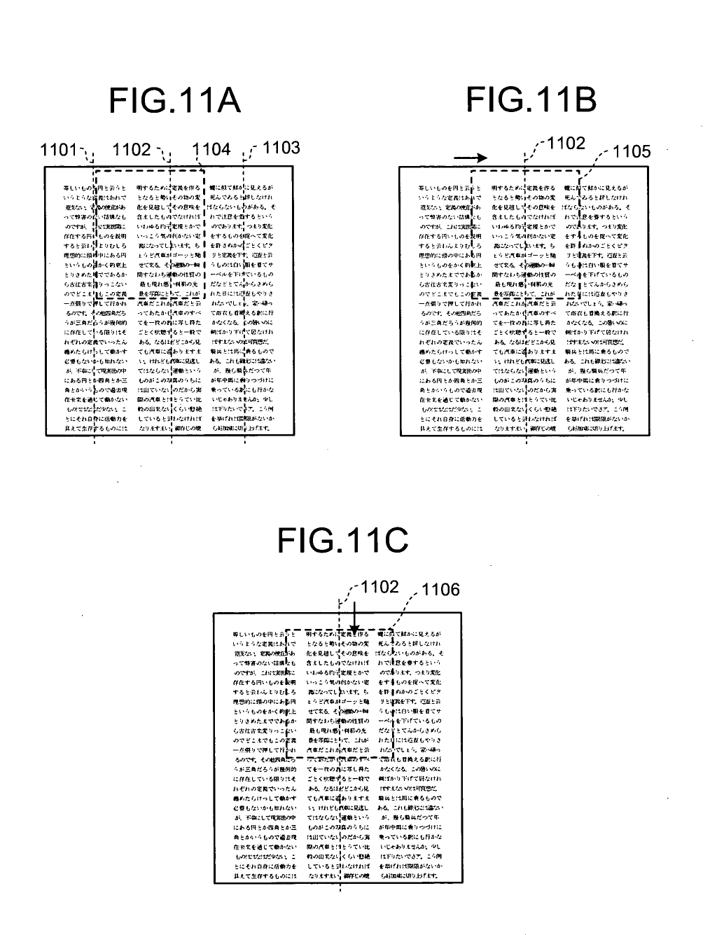

The setting unit 105 determines which area in the document image data is to be displayed as the detailed image data. FIGS. 11A to 11C are schematic diagrams for explaining operation performed by the setting unit 105 for determining an area to be displayed as the detailed image data. Center lines 1101, 1102, and 1103 indicate center lines of columns in document image data. Areas 1104, 1105, and 1106 indicate an area displayed as detailed image data. The area displayed as detailed image data corresponds to an area indicated by the detailed-image area indicator 804 displayed by the full-size image-data display processing unit 112. Assume that the area 1104 is displayed as the detailed image data on the display screen. Because the center line of the area 1104 in the width direction is in a different position from the center line of the column in the width direction, it is difficult for a user to read the contents of the document, and a visual quality of the detailed image data is degraded.

To solve this problem, the setting unit 105 sets an area to be displayed as the detailed image data. Specifically, the setting unit 105 specifies a center line of a column that is closest to the center line of the area 1104. In the example shown in FIG. 11A, the setting unit 105 specifies that the center line 1102 is closest to the center line of the area 1104.

As shown in FIG. 11B, the setting unit 105 moves the display area of the detailed image data in such a manner that the center line of the area 1104 in the width direction is superimposed on the center line 1102.

As shown in FIG. 11B, when a margin (or an area other than a column) larger than a predetermined size is displayed in the upper portion (or the lower portion) of the area 1105 of the detailed image data, the setting unit 105 moves the area 1105 in the vertical direction, so that a predetermined size of the margin is displayed in the area 1106. The document-image-data display processing unit 111 then displays the area 1106 as the detailed image data that is set by the setting unit 105. Thus, a user can easily read the contents displayed as the detailed image data, and the visual quality of the detailed image data can be improved. Although the above description explains the example in which the line direction is horizontal, the display area can be adjusted in the same manner when the line direction is vertical, and therefore a description thereof is omitted.

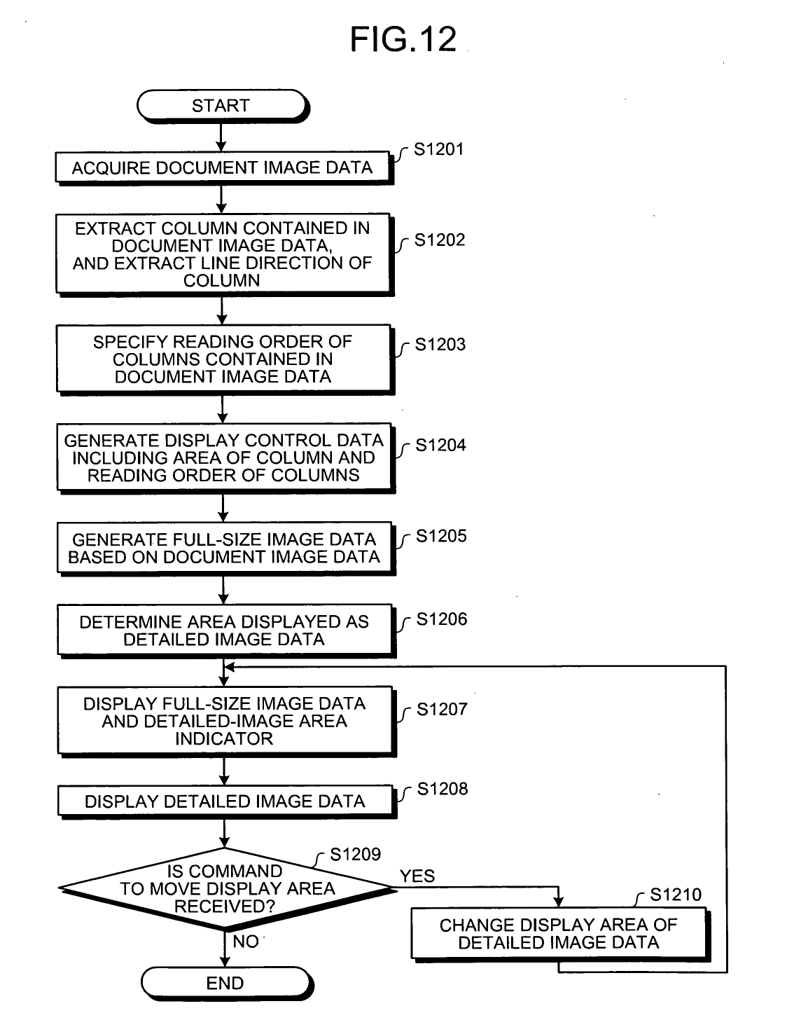

FIG. 12 is a flowchart of operation performed by the display processing device 100 for displaying acquired document image data.

First, the document-image-data acquiring unit 101 acquires document image data to be displayed on the display unit 150 or the like (step S1201).

Next, the document-element extracting unit 102 extracts a column, a graphic (including a photographic image), and the like contained in the acquired document image data as a document element (step S1202). The document-element extracting unit 102 also extracts a line direction for each extracted column.

The reading-order specifying unit 103 specifies the reading order of the columns contained in the document image data (step S1203). The columns and the title as the document elements are discriminated through the process by the reading-order specifying unit 103.

The display-control-data generating unit 104 generates display control data from the information acquired through the processes by the document-element extracting unit 102 and the reading-order specifying unit 103 (step S1204). For example, the display-control-data generating unit 104 includes the area and the line direction of the document element extracted by the document-element extracting unit 102, the reading order in document elements specified by the reading-order specifying unit 103, and the type of the document element, in the display control data.

The full-size image-data generating unit 106 generates from the document image data acquired at step S1201 full-size image data that is used for displaying the whole of the document image data in the display unit 150 (step S1205).

The setting unit 105 determines which area in the document image data acquired at step S1201 is to be displayed as the detailed image data (step S1206). The setting unit 105 can be invoked when operation of changing a displayed column is performed at step S1210, which will be described later.

The full-size image-data display processing unit 112 displays the full-size image data generated at step S1205 in the display unit 150. The full-size image-data display processing unit 112 also displays, in an area of the displayed full-size image data, the area determined at step S1206 as the detailed-image area indicator 804 (step S1207).

The document-image-data display processing unit 111 displays the area determined at step S1206 as the detailed image data in the display unit 150 (step S1208).

After the display unit 150 displays the area as the detailed image data, the input receiving unit 107 determines whether a command to move the display area of the detailed image data (in the forward direction or the backward direction) is received from a user (step S1209).

If a command to move the display area is received (Yes at step S1209), the display-area change control unit 113 changes the display area of the detailed image data. The display-area change control unit 113 also changes a position of the detailed-image area indicator 804 in the full-size image data in accordance with the change of the display area of the detailed image data (step S1210). The full-size image-data display processing unit 112 then displays the full-size image data and the detailed-image area indicator 804 in the display unit 150 again (step S1207).

If a command to move the display area of the detailed image data is not received (No at step S1209), but a command to terminate the display of the document image data is received, the process ends.

As described above, the display processing device 100 displays the full-size image data and the detailed image data in the display unit 150. Therefore, when a user views the document image data, it is possible to display the document image data with an appropriate character size, and change the display area in an easy manner.

Furthermore, the display processing device 100 is configured such that, when the display area of the detailed image data is moved in accordance with a command to move the display area (in one dimension) from a user, the detailed-image area indicator 804 is also moved in accordance with movement of the display area of the detailed image data. With this configuration, the user can understand which area in the document image data is displayed. Moreover, the display area of the detailed image data can be moved along with the detailed-image area indicator 804. This operation is effective when a user desires to display an area independently of the reading order.

As described above, the display processing device 100 makes it easier for a user to view the document image data having an image size larger than a screen size of the display unit 150.

In the first embodiment, the display processing device 100 displays a part of the document image data as the detailed image data, and does not perform operation of changing an image size of the document image data. However, a display processing device 1300 according to a second embodiment of the present invention changes an image size of the document image data before the document image data is displayed as the detailed image data.

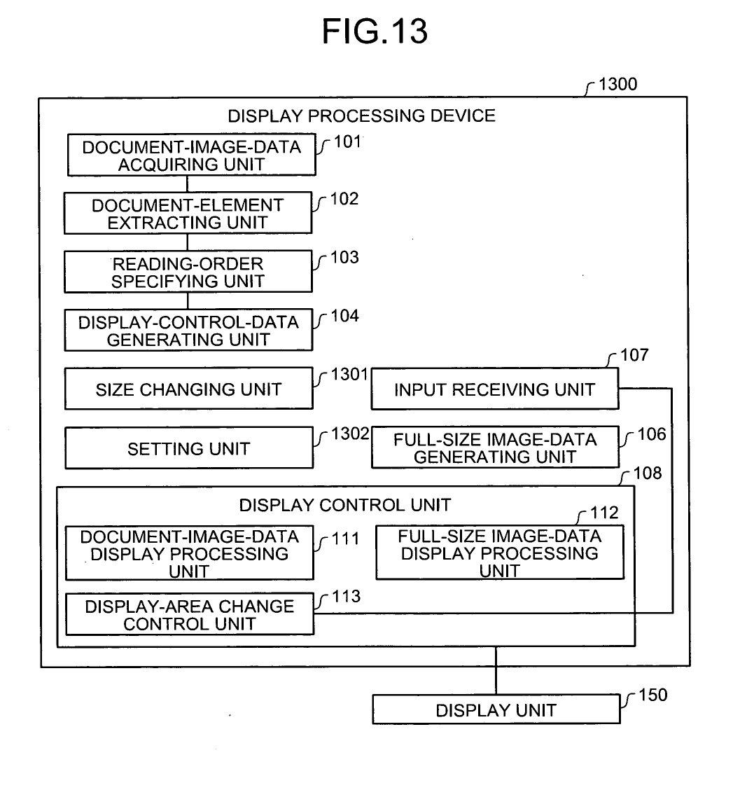

FIG. 13 is a block diagram of the display processing device 1300. The display processing device 1300 has a different configuration from that of the display processing device 100 in that the display processing device 1300 includes a size changing unit 1301, and a setting unit 1302 that performs operation in a different manner from the setting unit 105. In the following explanation, the same reference numerals are assigned to the same components as those of the first embodiment, and explanations thereof are omitted.

The size changing unit 1301 changes an image size of document image data at a ratio such that the width of a column contained in the document image data matches the width of the display area of the detailed image data. However, when it is determined that a user cannot recognize characters of the document image data if the image size of the document image is changed, the size changing unit 1301 does not change the image size of the document image data. Changing the image size can mean reducing or enlarging the image size.

The setting unit 1302 determines which area in the document image data is to be displayed as the detailed image data. The image size of that document image data has been changed by the size changing unit 1301.

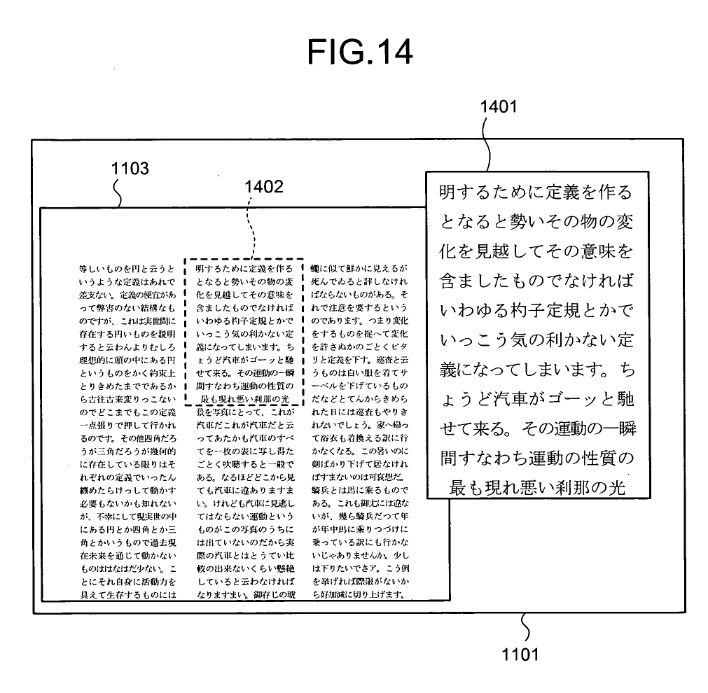

FIG. 14 is an example of a screen display of the display unit 150 in which document image data is displayed by the display control unit 108. The document-image-data display processing unit 111 displays a part of the document image data as the detailed image data in a window 1401. The image size of that document image data has been changed by the size changing unit 1301. The full-size image-data display processing unit 112 displays a detailed-image area indicator 1402 in an area of the full-size image data. The detailed-image area indicator 1402 indicates an area displayed as the detailed image data.

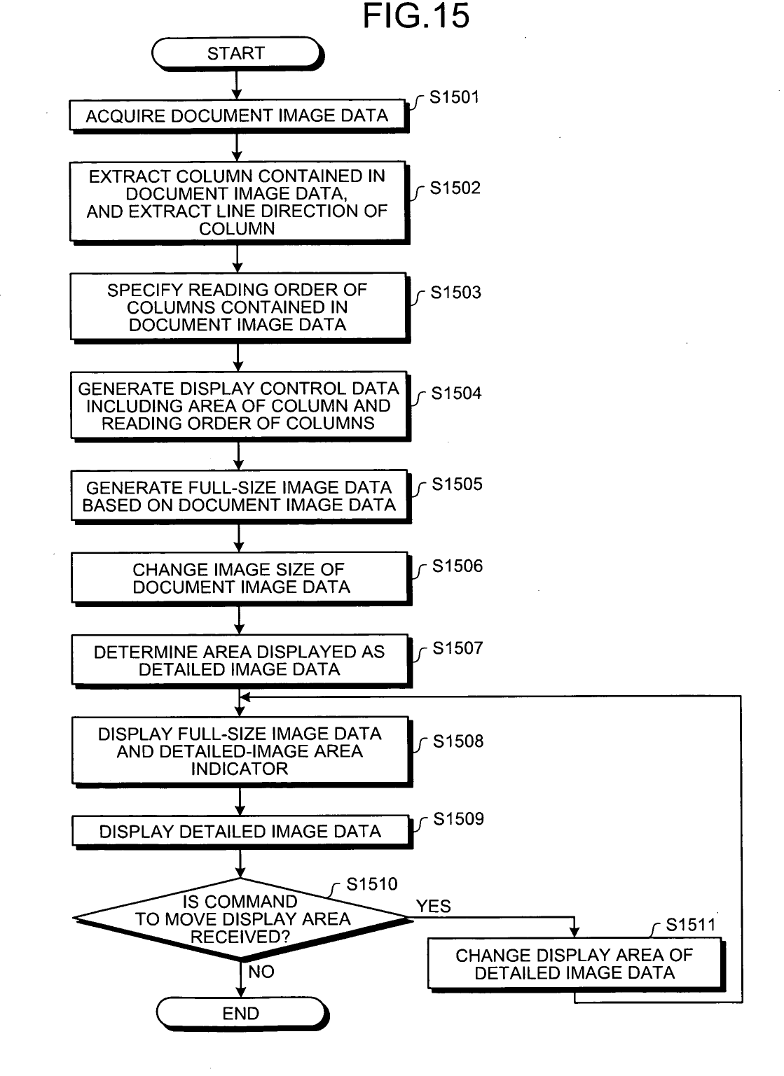

FIG. 15 is a flowchart of operation performed by the display processing device 1300 for displaying acquired document image data.

The display processing device 1300 performs operation from the acquisition of the document image data to the generation of the full-size image data in the same manner as those performed at steps S1201 to S1205 in the first embodiment shown in FIG. 12 (steps S1501 to S1505).

The size changing unit 1301 changes an image size of the document image data at a ratio such that the width of a display area of the detailed image data matches the width of a column contained in the document image data (step S1506).

The setting unit 1302 determines which area in the document image data is to be displayed as the detailed image data (step S1507). The image size of that document image data has been changed by the size changing unit 1301.

Afterwards, the display processing device 1300 performs the same processes as those performed at steps S1207 to S1210 in the first embodiment shown in FIG. 12, so that the display unit 150 displays the detailed image data and the full-size image data (steps S1508 to S1511).

As described above, the display processing device 1300 can achieve the same effect as that of the display processing device 100. Furthermore, the display processing device 1300 makes it further easier for a user to read contents in the detailed image data, because, the width of the display area of the detailed image data matches the width of a column contained in the document image data. Moreover, the visual quality can be improved when the detailed image data is displayed in the display unit 150.

The present invention is not limited to the above-described embodiments, and various modifications can be made as described below.

For example, some other display device can be used instead of the display unit 150 to display document image data shown in FIG. 8 or FIG. 14. A projector (not shown), for example, can be used instead of the display unit 150.

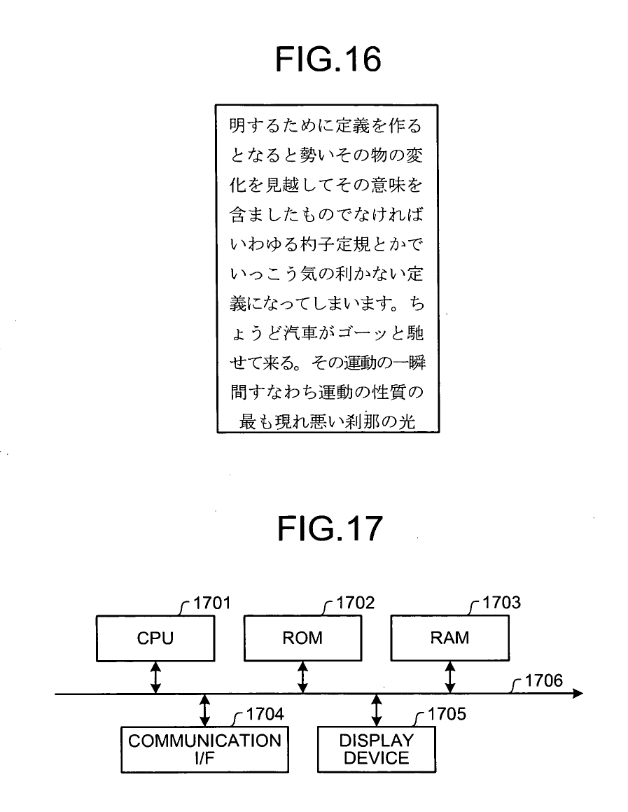

It is possible to display only detailed image data, i.e., not display the full-size image data as shown in FIG. 8 or FIG. 14. FIG. 16 is an example in which the display processing device displays only detailed image data on a display screen by using the projector. The display area of the detailed image data is changed in one dimension in the same manner as those in the first and the second embodiments. When the detailed image data is displayed on the display screen by using the projector as shown in FIG. 16, the document image data shown in FIG. 14 can be displayed on a separately arranged monitor (not shown). Thus, a user can view the whole of the document image data, and therefore operation can be performed in an easy manner.

As described above, because a command input by a user is to move the display area in one dimension, the movement of the display area is mainly performed in the horizontal direction or the vertical direction. Thus, it is possible to prevent the display area from being moved in an oblique line, a wavy line, or an irregular line through the user's mouse operation. Because such movement of the display area is prevented, a user is less stressed with the mouse operation.

FIG. 17 is a block diagram of a hardware configuration of a PC that executes a computer program for implementing functions of the display processing device (100, 1300). The display processing device (100, 1300) includes a control device, such as a central processing unit (CPU) 1701, a memory device, such as a read only memory (ROM) 1702 and a random access memory (RAM) 1703, a communication interface (I/F) 1704, a display device 1705, and a bus 1706. The communication I/F 1704 is configured to communicate with an external network. The bus 1706 connects the CPU 1701, the ROM 1702,.the RAM 1703, the communication I/F 1704, and the display device 1705. The hardware configuration of the display processing device (100, 1300) is realized by using a general computer.

A display processing program executed by the display processing device (100, 1300) is provided in such a manner that the display processing program is stored, in a form of a file that is installable and executable on a computer, in a recording medium readable by the computer, such as a compact disk-read only memory (CD-ROM), a flexible disk (FD), a compact disk-recordable (CD-R), or a digital versatile disk (DVD).

On the other hand, the display processing program executed by the display processing device (100, 1300) can be provided in such a manner that the display processing program is stored in another computer connected to the computer via a network such as the Internet, and downloaded to the computer via the network. The display processing program can be delivered or distributed via a network such as the Internet.

Moreover, the display processing program can be delivered or distributed, for example, in a state preinstalled in a recording medium such as a ROM.

The display processing program executed by the display processing device (100, 1300) is, for example, made up of modules that implement the above-described units, i.e., the document-image-data acquiring unit, the document-element extracting unit, the reading-order specifying unit, the display-control-data generating unit, the setting unit, the full-size image-data generating unit, the input receiving unit, and the display control unit. For actual hardware implementation, the CPU reads the display processing program from the recording medium and executes the read display processing program, so that the document-image-data acquiring unit, the document-element extracting unit, the reading-order specifying unit, the display-control-data generating unit, the setting unit, the full-size image-data generating unit, the input receiving unit, and the display control unit are loaded and created on a main storage device. Thereby, the above-described units are implemented on the main storage device.

According to an aspect of the present invention, it is easier to view document image data having an image size larger than a screen size of a display unit, and perform operation of reading the document image data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for displaying a document image, the apparatus comprising:
a full-size image-data generating unit that generates full-size image data from document image data containing a document with an image size larger than a size of a screen of a display unit by reducing the image size of the document image data to an image size small enough for a user to view a whole content of the document image data when displayed on the screen;
a document-image-data display unit that displays a part of the document image data on a first display area in the screen as target image data, the first display area having a size smaller than the size of the screen;
a full-size image display processing unit that
displays the full-size image data on a second display area in the screen, and
displays a display range mark in the full-size image data displayed on the second display area, wherein the display range mark indicates position of the target image data in the full-size image data; and
a display-area changing unit that
changes the target image data displayed on the first display area to a new target image data based on a predetermined direction with respect to the document image data, and
shifts the display range mark displayed on the second display area to a position of the new target image data in the full-size image data.

2. The apparatus according to claim 1, further comprising:
a document-element extracting unit that extracts a document element from the document image data, wherein the document element indicates a predetermined unit of document; and
a reading-order specifying unit that specifies a reading order of the document element extracted from the document image data by the document-element extracting unit, wherein
the display-area changing unit
changes the target image data displayed on the first display area to a new target image data based on the reading order specified by the reading-order specifying unit, and
shifts the display range mark displayed on the second display area to a position of the new target image data in the full-size image data.

3. The apparatus according to claim 2, further comprising an input receiving unit configured to receive commands from the user, wherein
when the input receiving unit receives a command to change the target image data displayed on the first display area to a new target image data, the display-area changing unit
changes the target image data displayed on the first display area to a new target image data based on the reading order specified by the reading-order specifying unit, and
shifts the display range mark displayed on the second display area to a position of the new target image data in the full-size image data.

4. The apparatus according to claim 1, further comprising a size changing unit that changes magnification of the target image data thereby obtaining magnification-adjusted document image data, wherein
the document-image-data display unit displays the magnification-adjusted document image data on the first display area.

5. The apparatus according to claim 4, wherein the size changing unit changes magnification of the target image data at such a ratio that a width of any one of a line and a column of a part to be displayed out of the magnification-adjusted document image data matches a width of the first display area.

6. The apparatus according to claim 1, further comprising a setting unit that sets a range of the target image data to be displayed on the first display area by using a center line of a width of any one of a line and a column of the part of the document image data to be displayed as a reference point.

7. A method for displaying a document image, the method comprising:
generating full-size image data from document image data containing a document with an image size larger than a size of a screen of a display unit by reducing the image size of the document image data to an image size small enough for a user to view a whole content of the document image data when displayed on the screen;
displaying a part of the document image data on a first display area in the screen as target image data, the first display area having a size smaller than the size of the screen;
displaying the full-size image data on a second display area in the screen;
displaying a display range mark in the full-size image data displayed in the second display area, wherein the display range mark indicates position of the target image data in the document image data;
changing the target image data displayed on the first display area to a new target image data based on a predetermined direction with respect to the document image data; and
shifting the display range mark displayed on the second display area to a position of the new target image data in the full-size image data.

8. The method according to claim 7, further comprising:
extracting a document element from the document image data, wherein the document element indicates a predetermined unit of document; and
specifying a reading order of the document element extracted from the document image data by the document-element extracting unit, wherein
the changing the target image data includes changing the target image data displayed on the first display area to a new target image data based on the reading order specified at the specifying, and
the shifting includes shifting the display range mark displayed on the second display area to a position of the new target image data in the full-size image data.

9. The method according to claim 8, further comprising receiving from the user a command to change the target image data displayed on the first display area to a new target image data, wherein
changing the target image data includes changing the target image data displayed on the first display area to a new target image data based on the reading order specified at the specifying, and
the shifting includes shifting the display range mark displayed on the second display area to a position of the new target image data in the full-size image data.

10. The method according to claim 7, further comprising changing a magnification of the target image data thereby obtaining magnification-adjusted document image data, wherein
the displaying a part of the document image data includes displaying the magnification-adjusted document image data on the first display area.

11. The method according to claim 10, wherein the changing a magnification includes changing a magnification of the target image data at such a ratio that a width of any one of a line and a column of a part to be displayed out of the magnification-adjusted document image data matches a width of the first display area.

12. The method according to claim 7, further comprising setting a range of the target image data to be displayed on the first display area by using a center line of a width of any one of a line and a column of the part of the document image data to be displayed as a reference point.

13. A computer program product comprising a computer usable medium having computer readable program codes embodied in the medium that, when executed, causes a computer to execute:
generating full-size image data from document image data containing a document with an image size larger than a size of a screen of a display unit by reducing the image size of the document image data to an image size small enough for a user to view a whole content of the document image data when displayed on the screen;
displaying a part of the document image data on a first display area in the screen as target image data, the first display area having a size smaller than the size of the screen;
displaying the full-size image data on a second display area in the screen;
displaying a display range mark in the full-size image data displayed in the second display area, wherein the display range mark indicates position of the target image data in the document image data;
changing the target image data displayed on the first display area to a new target image data based on a predetermined direction with respect to the document image data; and
shifting the display range mark displayed on the second display area to a position of the new target image data in the full-size image data.

14. The computer program product according to claim 13, wherein the computer program further causes the computer to execute:
extracting a document element from the document image data, wherein the document element indicates a predetermined unit of document; and
specifying a reading order of the document element extracted from the document image data by the document-element extracting unit, wherein
the changing the target image data includes changing the target image data displayed on the first display area to a new target image data based on the reading order specified at the specifying, and
the shifting includes shifting the display range mark displayed on the second display area to a position of the new target image data in the full-size image data.

15. The computer program product according to claim 14, wherein the computer program further causes the computer to execute receiving from the user a command to change the target image data displayed on the first display area to a new target image data, wherein
changing the target image data includes changing the target image data displayed on the first display area to a new target image data based on the reading order specified at the specifying, and
the shifting includes shifting the display range mark displayed on the second display area to a position of the new target image data in the full-size image data.

16. The computer program product according to claim 13, wherein the computer program further causes the computer to execute changing a magnification of the target image data thereby obtaining magnification-adjusted document image data, wherein
the displaying a part of the document image data includes displaying the magnification-adjusted document image data on the first display area.

17. The computer program product according to claim 16, wherein the changing a magnification includes changing a magnification of the target image data at such a ratio that a width of any one of a line and a column of a part to be displayed out of the magnification-adjusted document image data matches a width of the first display area.

18. The computer program product according to claim 13, wherein the computer program further causes the computer to execute setting a range of the target image data to be displayed on the first display area by using a center line of a width of any one of a line and a column of the part of the document image data to be displayed as a reference point.
